(19) United States
(12) Patent Application Publication
(10) Pub. No.: US 2017/0279208 A1
(43) Pub. Date: Sep. 28, 2017

(54) ELECTRICAL UNIT AND HEADER RETENTION SYSTEM THEREFOR

(71) Applicant: Lear Corporation, Southfield, MI (US)

(72) Inventors: Ferran Juanes Ribas, Valls (ES); Montserrat Pinol Pedret, Valls (ES); Enric Aparicio Rollan, Valls (ES); Joan Ignasi Ferran Palau, Valls (ES); Jose Antonio Cubero Pitel, Valls (ES)

(21) Appl. No.: 15/444,361

(22) Filed: Feb. 28, 2017

Related U.S. Application Data
(60) Provisional application No. 62/312,861, filed on Mar. 24, 2016.

(51) Int. Cl. H01R 12/71; H01R 12/70

(52) U.S. Cl. CPC H01R 12/714; H01R 12/7005

(57) ABSTRACT

An electrical unit includes a housing member, a circuit board, a header connected to the housing member, and a plurality of electrical terminals disposed in the header and connected to the circuit board. The header may be connected to the housing member such that movement of the header is restricted and forces applied to the circuit board via the housing member are limited. The header may include a retainer configured to retain the header relative to the housing member. The housing member may include a latch configured to engage the retainer.

### CROSS-REFERENCE TO RELATED APPLICATION

This application claims the benefit of U.S. Provisional Application Ser. No. 62/312,861, filed Mar. 24, 2016, the disclosure of which is hereby incorporated herein by reference in its entirety.

### TECHNICAL FIELD

The present disclosure relates to circuit boards, headers, electrical units, power distribution units, electrical junction boxes, electrical housings, electronic control units, gateway units, and body domain controllers, including those that may be used in vehicles.

### BACKGROUND

This background description is set forth below for the purpose of providing context only. Therefore, any aspects of this background description, to the extent that it does not otherwise qualify as prior art, is neither expressly nor impliedly admitted as prior art against the instant disclosure.

In some circumstances, connector mating operations (e.g., between connectors and/or units, such as junction boxes and/or wiring harness connectors) may result in relatively large amounts of strain being transferred to, applied to, and/or experienced by a circuit board (e.g. a printed circuit board (PCB)). For example, for cost saving purposes, a connection mating element may be formed with pin terminals grouped in a header that may be separate from a connection housing, which may be part of an electrical unit (e.g., as opposed to a complete connector device in which the connection housing may be integrated with pin terminals).

There is therefore a desire for solutions/options that minimize or eliminate one or more of the above-described challenges. The foregoing discussion is intended only to illustrate examples of the present field and should not be taken as a disavowal of scope.

### SUMMARY

In embodiments, an electrical unit may include a housing member, a circuit board, a header connected to the housing member, and/or a plurality of electrical terminals disposed in the header and connected to the circuit board. The header may be connected to the housing member such that movement of the header is restricted and forces applied to the circuit board via the housing member are limited. The header may include a retainer configured to retain the header relative to the housing member. The housing member may include a latch configured to engage the retainer.

In embodiments, a method of assembling a junction box may include providing a housing member, providing a circuit board, providing a header, connecting electrical terminals of the header to the circuit board, connecting the header to the housing member, and/or restricting the header from applying forces to the circuit board. A connector may be connected with the electrical terminals.

The foregoing and other aspects, features, details, utilities, and advantages of the present disclosure will be apparent from reading the following description, and from reviewing the accompanying drawings.

### BRIEF DESCRIPTION OF THE DRAWINGS

FIG. 1 is a cross section of an electrical unit with a housing member, a circuit board, and a header.

FIG. 2A is a finite element analysis (FEA) image of a cross section an electrical unit with a housing member, a circuit board, and a header during a mating operation.

FIG. 2B is an FEA image of a circuit board during a mating operation.

FIG. 3A is an exploded perspective view of an embodiment of an electrical unit with a first housing member, a second housing member, a circuit board, and a plurality of headers in accordance with teachings of the present disclosure.

FIG. 3B is perspective view of an embodiment of a connector.

FIG. 4 is a cross-sectional view of an embodiment of an electrical unit with a housing member, a header, and a circuit board according to teachings of the present disclosure.

FIG. 5 is a perspective view of an embodiment of a header with electrical terminals according to teachings of the present disclosure.

FIG. 6 is a cross-sectional view of an embodiment of a housing member according to teachings of the present disclosure.

FIGS. 7A and 7B are cross-sectional views of embodiments of housing members and headers according to teachings of the present disclosure.

FIG. 7C is a top view of an embodiment of a housing member according to teachings of the present disclosure.

FIG. 8A is an FEA image of an embodiment of a circuit board during a mating operation with movement of a header restricted via a housing member and two retainers according to teachings of the present disclosure.

FIG. 8B is an FEA image of a circuit board during a mating operation with movement of a header restricted via a housing member and four retainers according to teachings of the present disclosure.

FIG. 9 is a cross section of an electrical unit with a housing member, a circuit board, a header, and an adhesive.

FIG. 10 is a cross-sectional view of an embodiment of an electrical unit with a housing member, a header, an adhesive, and a circuit board according to teachings of the present disclosure.

FIG. 11 is a perspective view of an embodiment of a header with electrical terminals and adhesive according to teachings of the present disclosure.

FIG. 12 is an exploded perspective view of an embodiment of an electrical unit with a first housing member, a second housing member, a circuit board, an adhesive, and a header in accordance with teachings of the present disclosure.

### DETAILED DESCRIPTION

Reference will now be made in detail to embodiments of the present disclosure, examples of which are described herein and illustrated in the accompanying drawings. While the disclosure will be described in conjunction with embodiments, it will be understood that they are not intended to limit the disclosure to these embodiments. On the contrary, the disclosure is intended to cover alternatives, modifications and equivalents, which may be included within the spirit and scope of the disclosure.

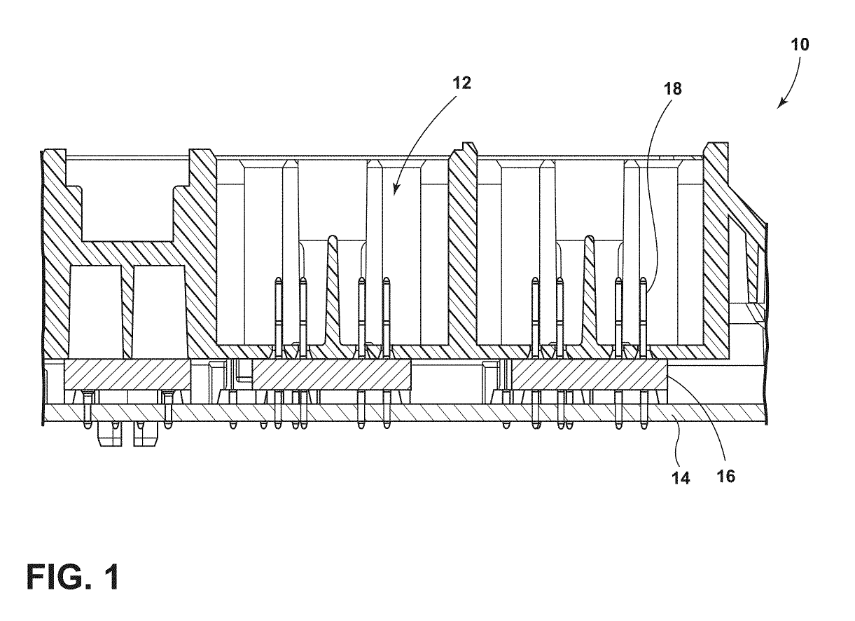

As generally illustrated in FIG. 1, an electrical unit 10 may include a housing member 12, a circuit board 14, a header 16, and one or more terminals 18. The one or more terminals 18 may be disposed in header 16 and/or may be connected to circuit board 14. Circuit board 14 may include, for example, a printed circuit board (PCB).

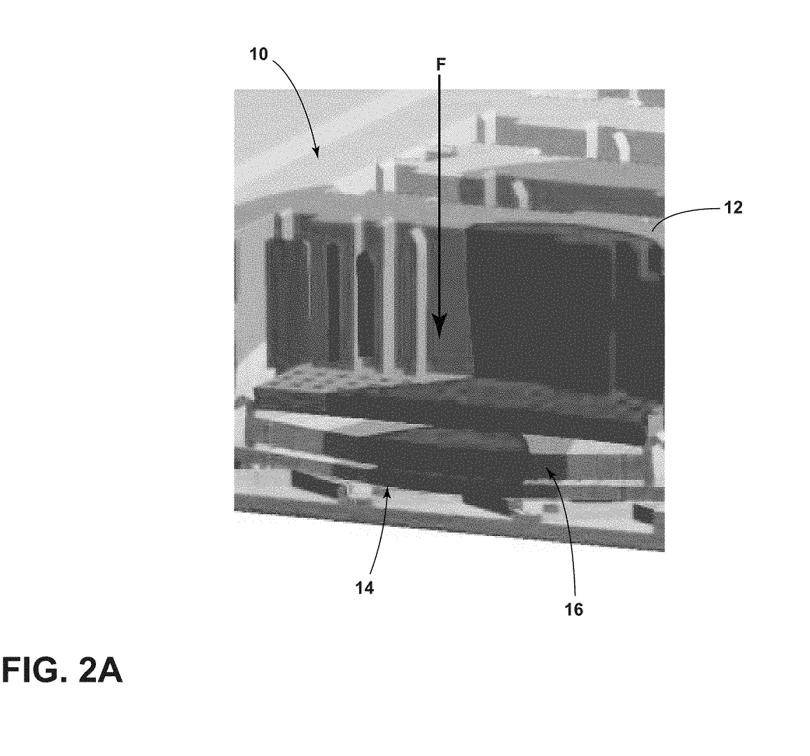

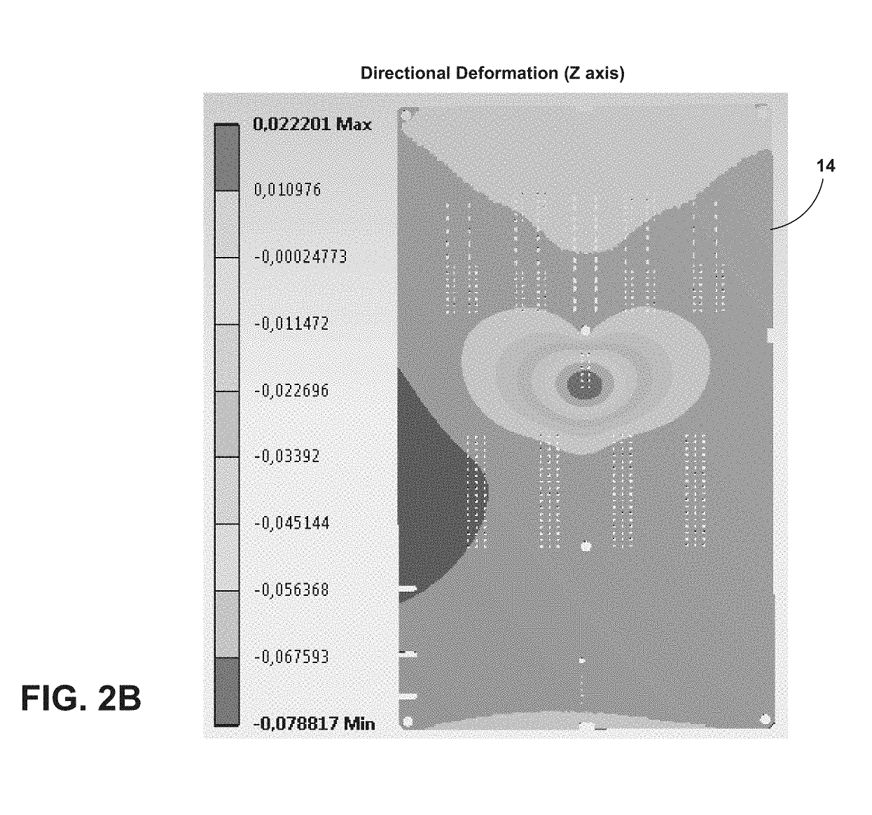

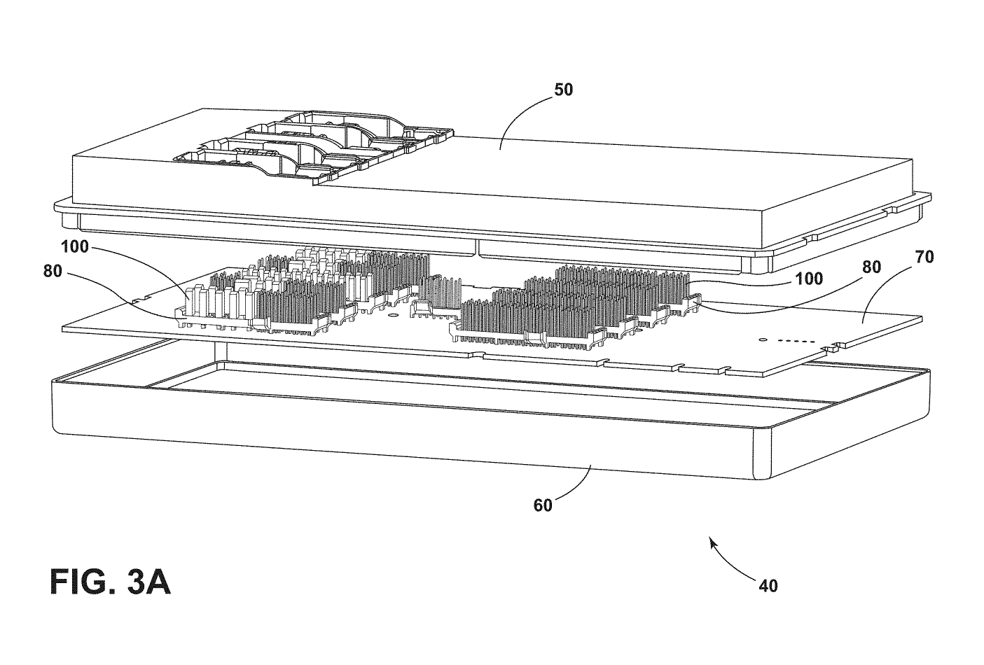

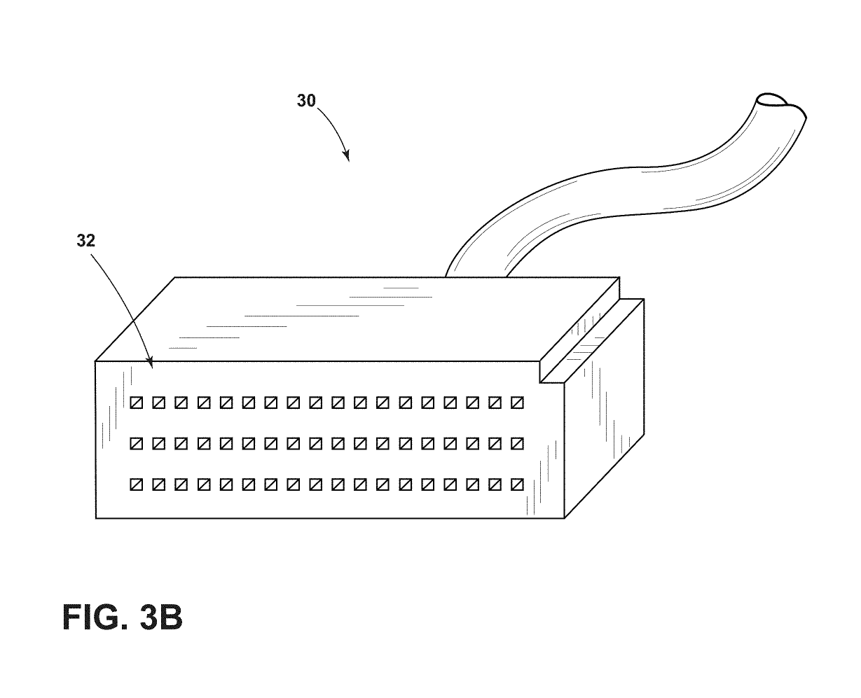

Electrical unit 10 may be configured for connection with a connector (see, e.g., FIG. 3B). As generally illustrated in FIGS. 2A and 2B, which include FEA images during a mating operation (e.g., connection/mating of electrical unit 10 and terminals 18 with connector 30), forces F may be applied to electrical unit 10, header 16, and/or circuit board 14 during mating. For example, and without limitation, connecting connector 30 with the one or more terminals 18 may apply a force F to header 16 and/or terminals 18 toward circuit board 14 and the force F may be sufficiently large that a relatively significant amount of the force F may be transferred/applied to circuit board 14. In some instances, the amount of force F transferred/applied to circuit board 14 may result in more deformation/strain of the circuit board than is desired (e.g., more than a threshold amount of deformation/strain). Increased deformation/strain of circuit board 14 may damage circuit board 14 and/or may damage components connected to circuit board 14, such as surface mount devices (SMDs).

In embodiments, such as generally illustrated in FIGS. 3A and 3B, an electrical unit 40 may include a first housing member 50, a second housing member 60, a circuit board 70, one or more headers 80, and one or more electrical terminals 100. Electrical unit 40 may be configured for connection with a connector 30, which may include connector 30 receiving at least a portion of one or more electrical terminals 100 and/or electrically connecting connector 30 with circuit board 70. Electrical unit 40 may include, for example, one or more electrical housings, electrical junction boxes, smart junction boxes, electronic control units, gateway units, body domain controllers, and/or power distribution boxes.

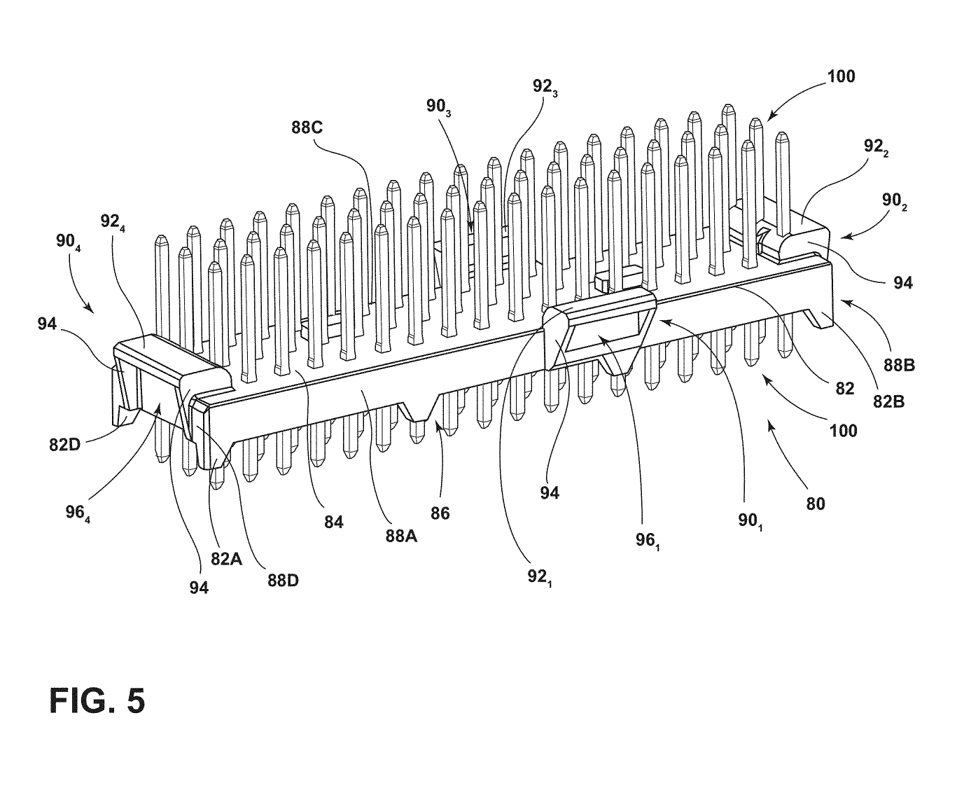

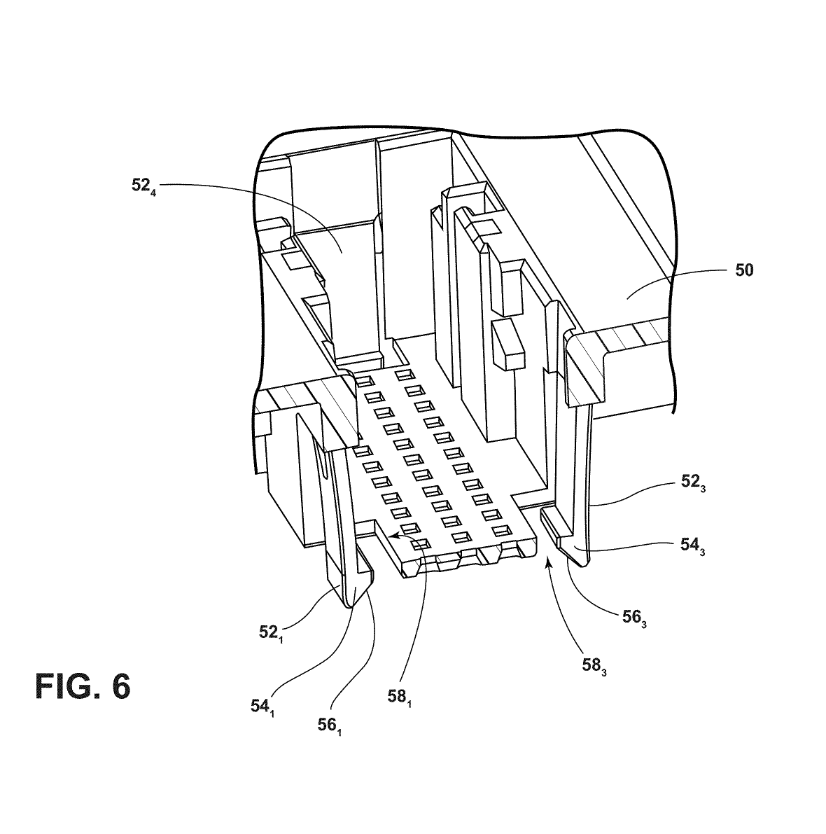

As generally illustrated in FIGS. 3A, 5, 6, 7A, and 7B, a header 80 may comprise one of more of a variety of shapes, sizes, configurations, and/or materials. Header 80 may be configured to support electrical terminals 100, such as before, during, and/or after connection with circuit board 70. Header 80 may include a body 82, which may include a top 84, a bottom 86, and one or more lateral sides 88A, 88B, 88C, 88D (e.g., left, right, front, and back if body 82 includes a generally rectangular shape). One or more electrical terminals 100 may be disposed in body 82. For example, and without limitation, electrical terminals 100 may extend beyond bottom 86 of header 80 for connection with circuit board 70 and/or electrical terminals 100 may extend beyond top 84 of header 80 for connection with a connector 30 (e.g., via extending through housing member 50). Header 80 may include one or more retainers 90_{N} that may be configured to retain and/or restrict movement of header 80 relative to first housing member 50. For example, and without limitation, a header 80 may include four retainers 90₁, 90₂, 90₃, 90₄ that may be disposed at or about each lateral side 88A, 88B, 88C, 88D of header 80. Retainers 90_{N} may extend generally away from body 82 horizontally/laterally (e.g., outward from lateral sides 88A, 88B, 88C, 88D), and/or vertically (e.g., from/above top 84, away from circuit board 70). Retainers 90_{N} may include a flange 92_{N} that may be configured to engage housing member 50 and/or that may be supported by one or more support portions 94. Retainer support portions 94 may be tapered such that the lateral depth of support portions 94 increases moving vertically away from header bottom 86 and/or away from circuit board 70.

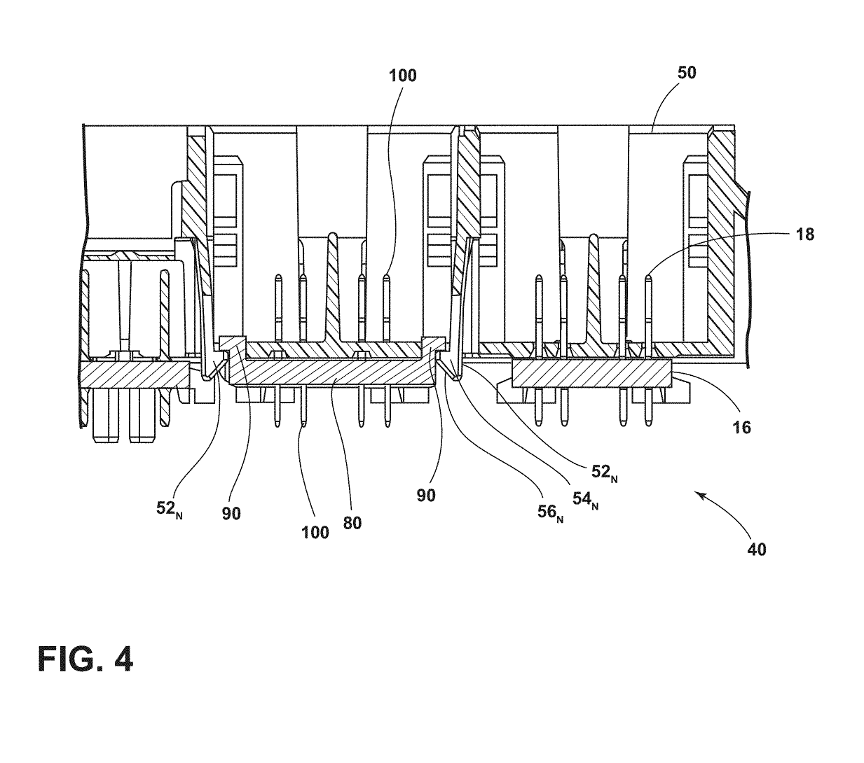

As generally illustrated in FIGS. 3A, 4, 6, 7A, 7B and 7C, housing member 50 may include one or more latches 52_{N} that may be configured to engage corresponding retainers 90_{N} of a header 80. For example, and without limitation, housing member 50 may include latches 52₁, 52₂, 52₃, 52₄ that may be configured to engage retainers 90ₖ, 90₂, 90₃, 90₄, respectively. Latches may extend generally vertically downward toward header 80 and/or circuit board 70. Latches 52_{N} may include hooked portions 54_{N} that may, for example, extend generally laterally inward. Flanges 92_{N} of retainers 90_{N} may include recesses 96_{N} that may be configured to at least partially receive hooked portions 54_{N}. Hooked portions 54_{N} may include tapered surfaces 56_{N} that may be configured to engage retainers 90_{N} upon connection of housing member 50 with header 80. Tapered surfaces 56_{N} may cause latches 52_{N} to deflect generally laterally outward upon initial contact with header 80. As housing member 50 and header 80 are moved closer together, hooked portions 54_{N} may, for example, be configured to move slightly below retainers 90_{N}, which may allow latches 52_{N} to snap back (e.g., laterally inward) such that hooked portions 54_{N} engage flange recesses 96_{N}. Latches 52_{N} may be at least somewhat resilient and/or may be biased laterally inward (e.g., into contact with header 80). Header 80 may be disposed at least partially between housing member 50 and circuit board 70.

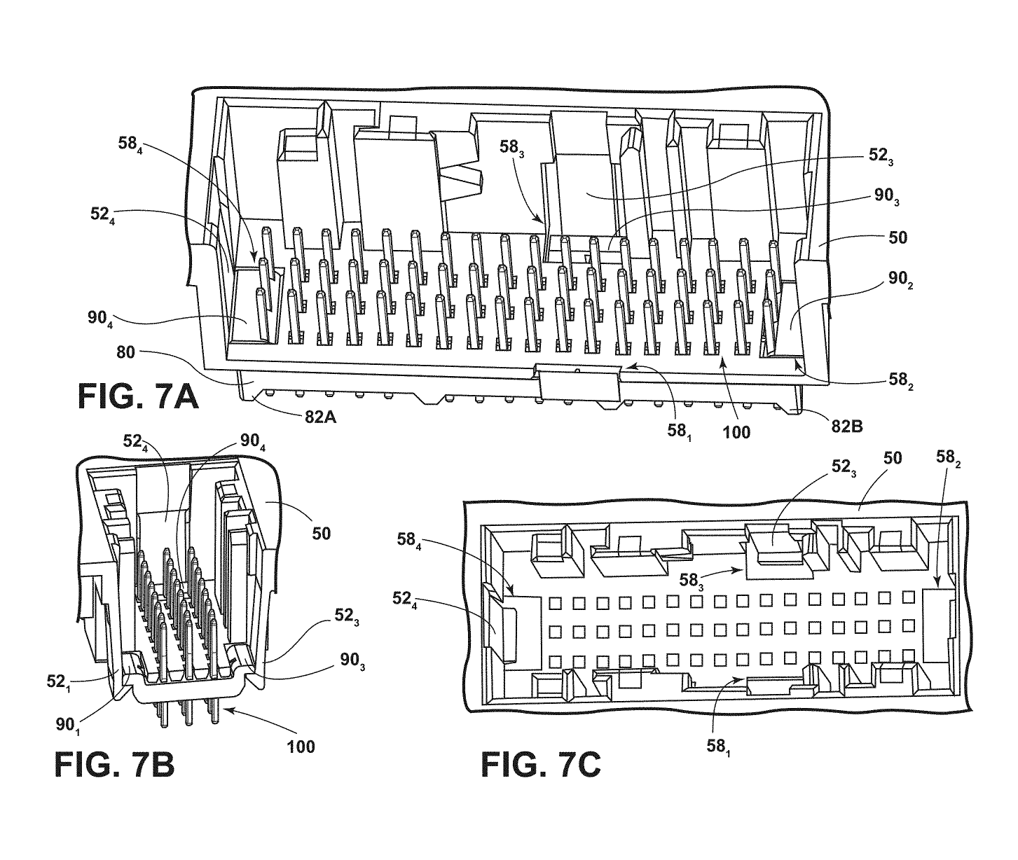

As generally illustrated in FIGS. 7A, 7B, and 7C, in embodiments, housing member 50 may be configured to at least partially receive retainers 90_{N}. For example, and without limitation, housing member 50 may include a retainer cut-out portion or aperture (e.g., aperture 58_{N}) for each retainer (e.g., four retainer apertures 58₁, 58₂, 58₃, 58₄). Retainer apertures 58_{N} may receive at least portions of retainers 90_{N} such that retainers 90_{N} extend into housing member 50. Latches 52_{N} may, for example, extend adjacent to or through retainer apertures 58_{N}. With embodiments, retainers 90_{N} may or may not be the only portions of header 80 disposed at least partially in housing member 50.

With embodiments, a method of assembling an electrical unit 40 (e.g., an electrical housing and/or junction box) may include providing a first housing member 50, a second housing member 60, a circuit board 70 (e.g., a PCB), and/or a header 80. Header 80 may be provided with one or more electrical terminals 100 that may be configured for connection with a connector 30 (e.g., of a wiring harness). The method may include connecting electrical terminals 100 to circuit board 70, which may include inserting electrical terminals 100 into and/or through circuit board 70 and connecting or fixing electrical terminals 100 to circuit board 70, such as via soldering. First housing member 50 may be connected to header 80. Connecting housing member 50 to header 80 may include disposing housing member 50 over header 80, aligning retainer apertures 58_{N} of housing member 50 with retainers 90_{N} of header 80, and/or sliding housing member 50 toward header 80. As housing member 50 and header 80 come into contact, latches 52_{N} may initially deflect laterally outward as tapered surfaces 56_{N} contact retainers 90_{N}. If housing member 50 and header 80 are moved closer together, hooked portions 54_{N} may move below retainers 90_{N}, which may allow latches 52_{N} to snap back (e.g., laterally inward) such that hooked portions 54_{N} engage flange recesses 96_{N}. The method may include retaining header 80 relative to housing member 50 via engagement between latches 52_{N} and retainers 90_{N} (e.g., between hooked portions 54_{N} and flange recesses 96_{N}). Retaining header 80 relative to housing member 50 may include restricting vertical movement of header 80 (e.g., downward movement of header 80), which may limit the forces applied to circuit board 70 and/or flexing of circuit board 70.

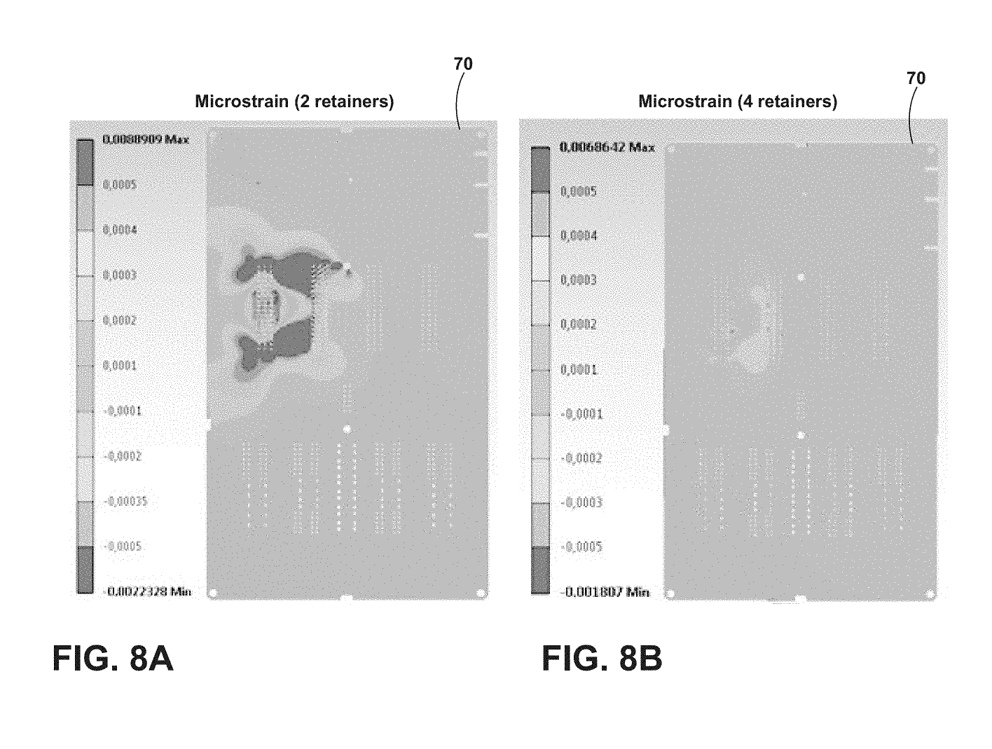

An assembly method (e.g., in a vehicle) may include connecting a connector 30 to electrical terminals 100 of header 80. Connecting connector 30 to electrical terminals 100 may include moving connector 30 downward toward housing member 50 such that apertures 32 of connector 30 receive electrical terminals 100. Connecting/mating may continue until electrical terminals 100 are fully inserted into connector 30. During connecting/mating, connector 30 may apply a downward vertical force F to header 80, such as via electrical terminals 100. Latches 52_{N} and retainers 90_{N} may cooperate to limit the downward movement of header 80 in response to such downward vertical force F, which may limit the downward force F applied to circuit board 70 during connecting/mating. Limiting the downward force F applied to circuit board 70 may limit the amount of deflection/deformation of circuit board 70, which may prevent damage to circuit board 70 and/or components connected to circuit board (e.g., SMDs). For example, and without limitation, FIGS. 8A and 8B include FEA images illustrating microstrain of a circuit board 70 during mating using a header 80 with two retainers 90_{N} and a header 80 with four retainers 90_{N}, respectively. As generally illustrated, a header 80 with four retainers 90_{N} may limit strain and/or deformation of circuit board 70 to a greater degree than a header 80 with two retainers 90_{N}.

With embodiments, latches 52_{N} and retainers 90_{N} may or may not be configured to limit movement of housing member 50 toward circuit board 70. For example, and without limitation, latches 52_{N} and retainers 90_{N} may limit movement of housing member 50 away from circuit board 70 (e.g., via connection (a) between electrical terminals 100 and circuit board 70, (b) between electrical terminals 100 and header 80, and (c) between retainers 90_{N} of header 80 and latches 52_{N} of housing member 50), but latches 52_{N} and retainers 90_{N} may not, on their own, limit movement of housing member 50 toward circuit board 70.

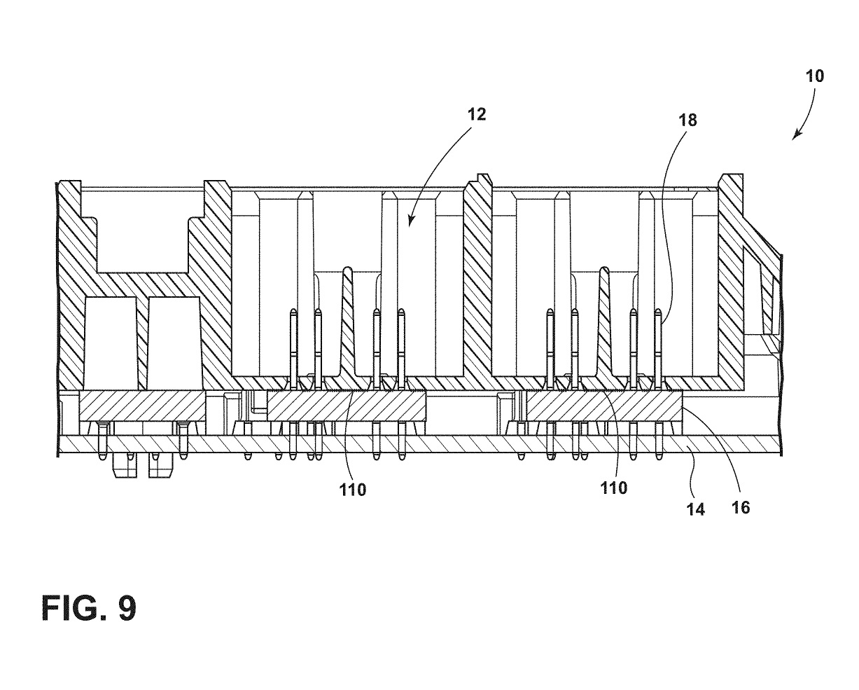

In embodiments, such as generally illustrated in FIGS. 9-12, an electrical unit, such as electrical units 10, 40, may include an adhesive 110. Adhesive 110 may include one or more of a variety of shapes, sizes, configurations, and/or materials. For example, and without limitations, adhesive 110 may include an adhesive foil. Adhesive 110 may be disposed between a header 16, 80 and a housing member 12, 50. Adhesive 110 may be configured to limit and/or impede movement of a header 16, 80 away from a housing member 12, 50. In a manner that may be similar to that associated with retainers 90_{N}, adhesive 110 may retain a header 16, 80 relative to housing member 50, which may limit the forces F applied to circuit board 70 and/or flexing of circuit board 70.

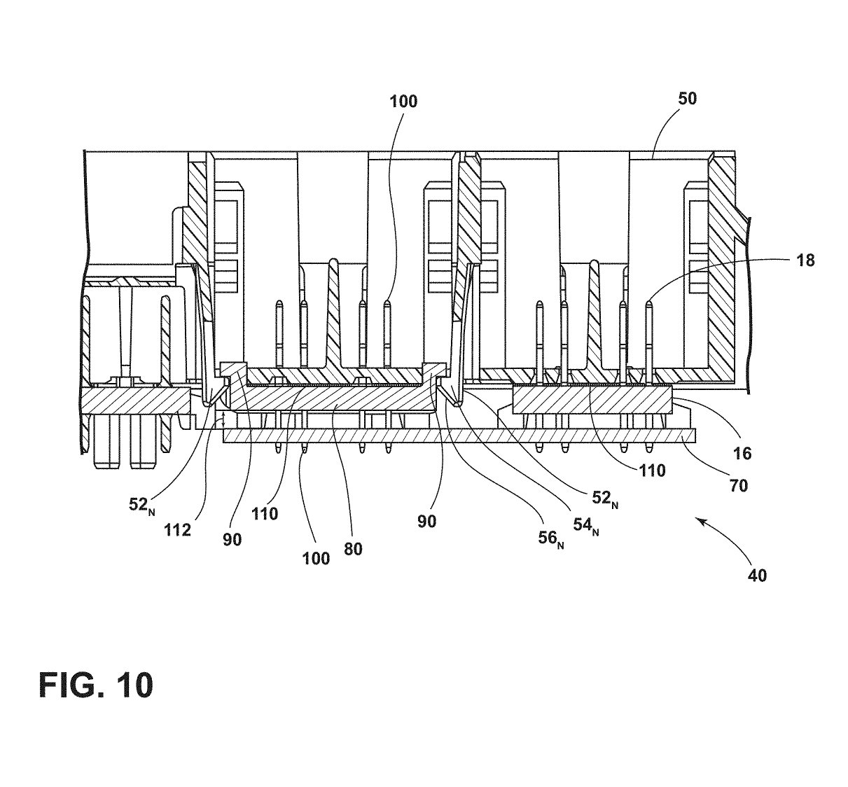

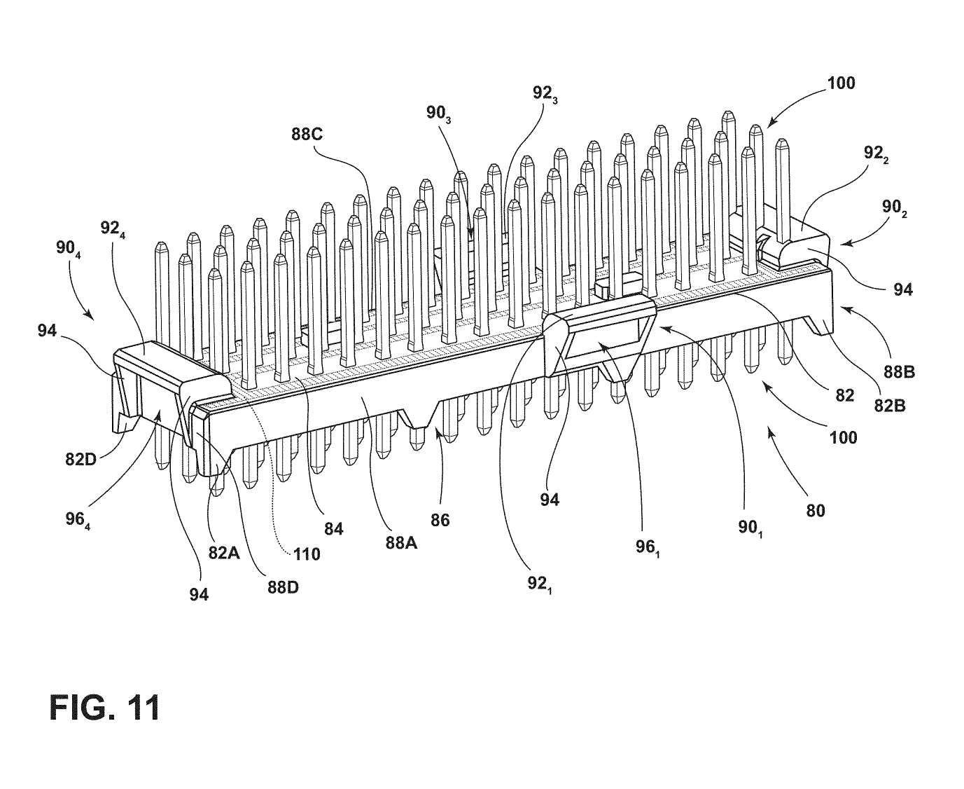

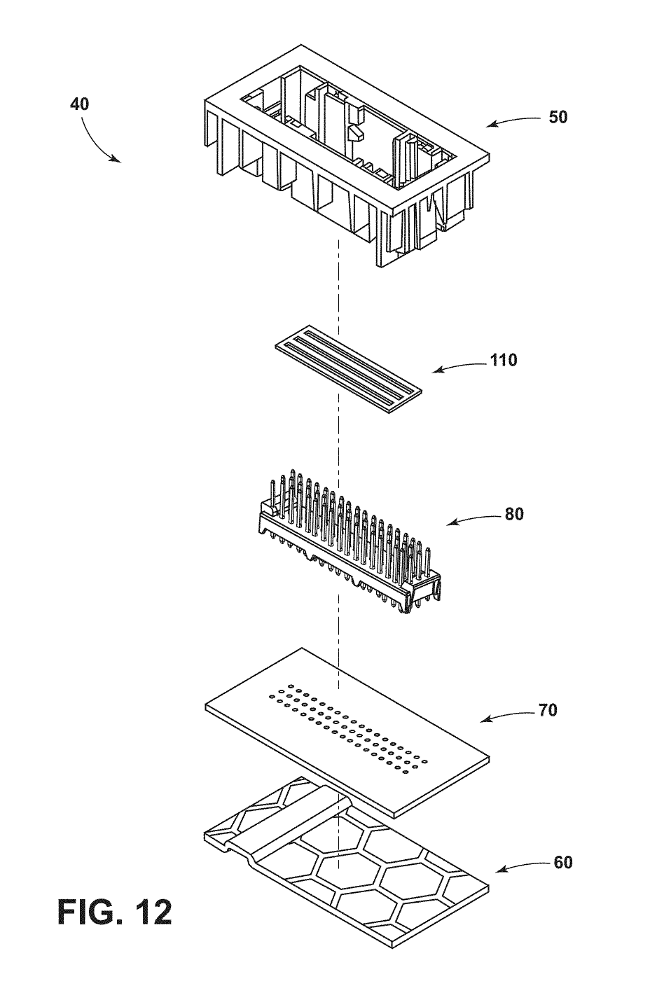

As generally illustrated in FIG. 9, adhesive 110 may be used with a header 16 that does not include retainers 90_{N}, in embodiments. As generally illustrated in FIG. 10, adhesive 110 may be used with a header 80 that includes retainers 90_{N} (e.g., an electrical unit 40 may include both retainers 90_{N} and adhesive 110). With embodiments, such as generally illustrated in FIGS. 11 and 12, adhesive 110 may be connected to a header 80 in one or more of a variety of configurations. Adhesive 110 may be connected at or about edges of header 80, at or about middle/central sections of header 80, and/or between terminals 100. Disposing adhesive 110 at or about middle/central sections of header 80 and/or between terminals 100 may help limit/prevent movement of the middle sections, which that may be disposed at greater distances from retainers 90_{N} that other sections of header 80, away from housing member 50. Terminals 100 may be disposed in rows and/or columns and adhesive 110 may be disposed between one or more of the rows and/or between the columns. For example, and without limitation, adhesive 110 may be disposed between each row of terminals 100 and/or along the perimeter of terminals 100 and/or header 80.

In embodiments, circuit board 70, header 80, adhesive 110, and/or first housing member 50 may be disposed generally parallel to each other and/or to the same plane (e.g., a horizontal plane). Circuit board 70, header 80, adhesive 110, and/or first housing member 50 may be disposed substantially adjacent to each other. A gap 112 (e.g., a vertical gap) may be disposed and/or present between header 80 and circuit board 70 (e.g., header body 82 may be spaced from circuit board 70, such as via feet 82A, 82B, 82D of header 80).

With embodiments, a method of assembling an electrical unit 40 (e.g., an electrical housing and/or junction box) may include providing a first housing member 50, a second housing member 60, a circuit board 70 (e.g., a PCB), a header 80, and/or an adhesive 110. Header 80 may be provided with one or more electrical terminals 100 that may be configured for connection with a connector 30 (e.g., of a wiring harness). The method may include connecting electrical terminals 100 to circuit board 70, which may include inserting electrical terminals 100 into and/or through circuit board 70 and connecting or fixing electrical terminals 100 to circuit board 70, such as via soldering. Adhesive 110 may be connected to header 80 and/or to first housing member 50. First housing member 50 may be connected to header 80. Connecting housing member 50 to header 80 may include disposing housing member 50 over header 80, aligning retainer apertures 58_{N} of housing member 50 with retainers 90_{N} of header 80, and/or sliding housing member 50 toward header 80. As housing member 50 and header 80 come into contact, latches 52_{N} may initially deflect laterally outward as tapered surfaces 56_{N} contact retainers 90_{N}. If housing member 50 and header 80 are moved closer together, hooked portions 54_{N} may move below retainers 90_{N}, which may allow latches 52_{N} to snap back (e.g., laterally inward) such that hooked portions 54_{N} engage flange recesses 96_{N}. Connecting first housing member 50 with header 80 may include connecting adhesive 110 to one or both of housing member 50 and header 80. For example, and without limitation, adhesive may be initially connected with (e.g., adhered to) header 80. As first housing member 50 and header 80 come together, adhesive may connect with first housing member 50, which may connect/bond first housing member 50 and header 80 together. In embodiments, adhesive 110 may be initially connected with first housing member 50. As first housing member 50 and header 80 come together, adhesive 110 may connect with first housing member 50, which may connect/bond first housing member 50 and header 80 together. With embodiments, adhesive 110 may be initially connected with first housing member 50 and header 80. As first housing member 50 and header 80 come together, adhesive 110 connected with first housing member 50 may connect/bond with adhesive 110 connected with header 80 (e.g., adhesive 110 may bond with itself and/or may include a two-part epoxy), which may connect/bond first housing member 50 and header 80 together.

A method of assembly may include retaining header 80 relative to housing member 50 via (i) engagement between latches 52_{N} and retainers 90_{N} (e.g., between hooked portions 54_{N} and flange recesses 96_{N}), and/or (ii) adhesive 110 binding first housing member 50 with header 80. Retaining header 80 relative to housing member 50 may include restricting vertical movement of header 80 (e.g., downward movement of header 80), which may limit the forces applied to circuit board 70 and/or flexing of circuit board 70.

With embodiments, retainers 90_{N} may be configured to help ensure a proper or desired positioning of header 80 relative to housing member 50. For example, and without limitation, retainers 90_{N} may at least initially align and/or connect header 80 with housing member 50, such as prior to adhesive 110 completely curing (e.g., retainers 90_{N} may help hold header 80 against housing member 50). This configuration may simplify and/or accelerate assembly such that an assembly process may not involve waiting for adhesive 110 to cure. In embodiments, adhesive 110 may be configured to provide sufficient resistance to movement of header 80 away from housing member 50 such that additional resistance, such as from retainers 90_{N}, may not be needed. Such an arrangement may permit retainers 90_{N} to be weaker and/or include less expensive materials as retainers 90_{N} may not be intended to connect header 80 to housing member 50 on their own.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

It should be understood that references to a single element are not so limited and may include one or more of such element. All directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” throughout the specification is to be construed broadly and is used to provide non-limiting examples of embodiments of the disclosure, and the disclosure is not limited to such examples. It is intended that all matter contained in the above description or shown in the accompanying drawings shall be interpreted as illustrative only and not limiting. Changes in detail or structure may be made without departing from the present disclosure.

Furthermore, the mixing and matching of features, elements and/or functions between various examples is expressly contemplated herein so that one of ordinary skill in the art would appreciate from this disclosure that features, elements, and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present teachings not be limited to the particular examples illustrated by the drawings and described in the specification.

What is claimed is:

1. An electrical unit, comprising:
a housing member;
a circuit board;
a header connected to the housing member; and
a plurality of electrical terminals disposed in the header and connected to the circuit board;
wherein the header is connected to the housing member such that movement of the header is restricted and forces applied to the circuit board via the housing member are limited.

2. The electrical unit of claim 1, wherein the header includes a retainer configured to retain the header relative to the housing member.

3. The electrical unit of claim 2, wherein the housing includes a latch configured to engage the retainer.

4. The electrical unit of claim 1, wherein the header includes a plurality of retainers configured to retainer the header relative to the housing member, and the housing member includes a plurality of latches configured to engage the plurality of retainers.

5. The electrical unit of claim 4, wherein at least one of the plurality of retainers includes a recess configured to receive a hooked portion of a latch of the plurality of latches.

6. The electrical unit of claim 5, wherein the hooked portion includes a tapered surface configured to engage the at least one retainer.

7. The electrical unit of claim 4, wherein at least one retainer of the plurality of retainers is disposed at or about each lateral side of the header.

8. The electrical unit of claim 7, wherein the header includes four lateral sides.

9. The electrical unit of claim 3, wherein the housing member includes a cut-out portion or aperture and the retainer is disposed in the cut-out portion or aperture.

10. The electrical unit of claim 3, wherein the latch member is configured to deflect laterally outward during mating of the housing member with the header.

11. The electrical unit of claim 10, wherein the latch member is biased laterally inward toward the header.

12. The electrical unit of claim 4, wherein the plurality of retainers extend laterally outward from a body of the header.

13. The electrical unit of claim 12, wherein the plurality of retainers extend vertically upward from the body and away from the circuit board.

14. The electrical unit of claim 9, wherein the latch is disposed in the cut-out portion or aperture.

15. The electrical unit of claim 1, including an adhesive disposed between the plurality of electrical terminals and connected to the first housing member and the header.

16. The electrical unit of claim 15, wherein the at least some of the adhesive is disposed at a central section of the header.

17. The method of claim 15, wherein the header, the housing member, the circuit board, and the adhesive are disposed substantially parallel with each other.

18. A method of assembling a junction box, the method comprising:
providing a housing member;
providing a circuit board;
providing a header having electrical terminals;
connecting the electrical terminals of the header to the circuit board; and
connecting the header to the housing member such that movement of the header is restricted to limit forces applied to the circuit board via the housing member.

19. The method of 18, wherein the header includes a retainer configured to retain the header relative to the housing member.

20. The method of claim 19, wherein the housing member includes a latch configured to engage the retainer.

21. The method of claim 18, wherein the header includes a plurality of retainers configured to retainer the header relative to the housing member, and the housing member includes a plurality of latches configured to engage the plurality of retainers.

22. The method of claim 21, wherein connecting the header to the housing member includes initially deflecting the plurality of latches laterally outward and snapping the latches inward to engage the plurality of retainers.

23. The method of claim 21, wherein connecting the header to the housing member includes inserting the retainers into corresponding apertures in the housing member.

24. The method of claim 18, wherein connecting the header to the housing member includes connecting the header and the housing member via an adhesive.

25. The method of claim 24, wherein the header, the housing member, the circuit board, and the adhesive are disposed generally parallel to a horizontal plane.
